(19) United States
(12) Patent Application Publication
(10) Pub. No.: US 2026/0054484 A1
(43) Pub. Date: Feb. 26, 2026

(54) NOZZLE SUBSTRATE

(71) Applicant: CANON KABUSHIKI KAISHA, Tokyo (JP)

(72) Inventor: SOUTA TAKEUCHI, Kanagawa (JP)

(21) Appl. No.: 19/300,878

(22) Filed: Aug. 15, 2025

(30) Foreign Application Priority Data
Aug. 22, 2024 (JP) 2024-140788

(51) Int. Cl. B41J 2/14

(52) U.S. Cl. CPC B41J 2/1433; B41J 2/14201; B41J 2002/14306

(57) ABSTRACT

Provided is a nozzle substrate configured by laminating a silicon substrate and a silicon oxide film covering a surface of the silicon substrate, and provided with a nozzle that discharges liquid, the nozzle substrate includes a through hole that penetrates the nozzle substrate and communicates with the nozzle, and a protective film that covers at least a surface of the silicon oxide film and an inner wall surface of the through hole and has resistance to the liquid, wherein a reflectance of white light on a surface of the nozzle substrate used in measuring the nozzle as a step by white light interferometry is 0.2 or more.

### BACKGROUND

### Field of the Technology

The present disclosure relates to a nozzle substrate having a nozzle that discharges liquid.

### Description of the Related Art

A head that discharges ink onto a recording medium in an inkjet recording apparatus includes a nozzle substrate having a nozzle that discharges the ink. The nozzle substrate has a silicon substrate provided with, on its surface, the nozzle that discharges the ink. Japanese Patent No. 5218164 describes a nozzle substrate that is configured by bonding glass to an SOI substrate, which is a silicon substrate covered with a silicon oxide film (SiO film).

In inkjet recording apparatuses, in order to improve the image quality, various types of ink having different color materials such as dyes and pigments, different ink solvents for stably dissolving color materials, and different physical properties such as acidity and alkalinity have been developed. Among them, it is known that pigment-based ink with a pH of about 8 to 9 erodes Si and SiO that form a nozzle substrate. Japanese Patent No. 4692534 describes a technique of providing ink resistance by continuously forming a protective film made of an oxide such as TaO from a surface on a droplet discharge side of a nozzle hole of a silicon nozzle substrate to an inner wall of the nozzle hole.

### SUMMARY

In order to ensure the recording quality of an inkjet recording apparatus, it is desirable to measure and manage dimensions such as an opening area of a nozzle of a nozzle substrate with high accuracy. As a method for measuring dimensions of the nozzle with high accuracy, there is a method for measuring a step at an edge portion of a nozzle opening using white light interferometry, which is a measurement method using white light (visible light). However, when the nozzle substrate is covered with a protective film, there are cases in which reflected light of white light used in white light interferometry is weak and measurement cannot be performed with high accuracy.

Thus, The present disclosure is directed to the technology to make it possible to accurately measure dimensions of a nozzle using white light interferometry in a nozzle substrate that is coated with a protective film to enhance resistance to liquid.

A nozzle substrate of the present disclosure, which is configured by laminating a silicon substrate and a silicon oxide film covering a surface of the silicon substrate, and is provided with a discharge port that discharges liquid, includes the following:
a nozzle configured to penetrate the nozzle substrate and communicate with the discharge port; and
a protective film configured to cover at least a surface of the silicon oxide film and an inner wall surface of the nozzle and have resistance to the liquid,
wherein a reflectance of white light on a surface of the nozzle substrate used in measuring the nozzle as a step by white light interferometry is 0.2 or more.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view of a nozzle substrate in a first embodiment;

FIG. 2 is a diagram showing a relationship between a SiO film thickness, a TaO film thickness, and a reflectance in the first embodiment;

FIG. 3 is a diagram showing appropriate film thicknesses in the first embodiment;

FIG. 4 is a cross-sectional view of a nozzle substrate in a second embodiment;

FIG. 5 is a diagram showing a relationship between a SiO film thickness, a SiC film thickness, and a reflectance in the second embodiment; and

FIG. 6 is a diagram showing appropriate film thicknesses in the second embodiment.

### DESCRIPTION OF THE EMBODIMENTS

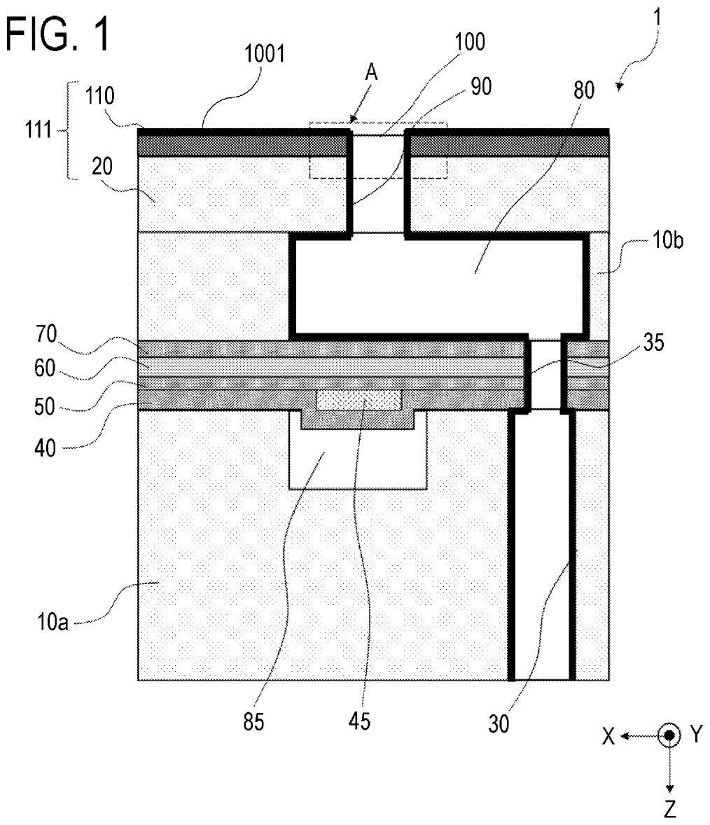

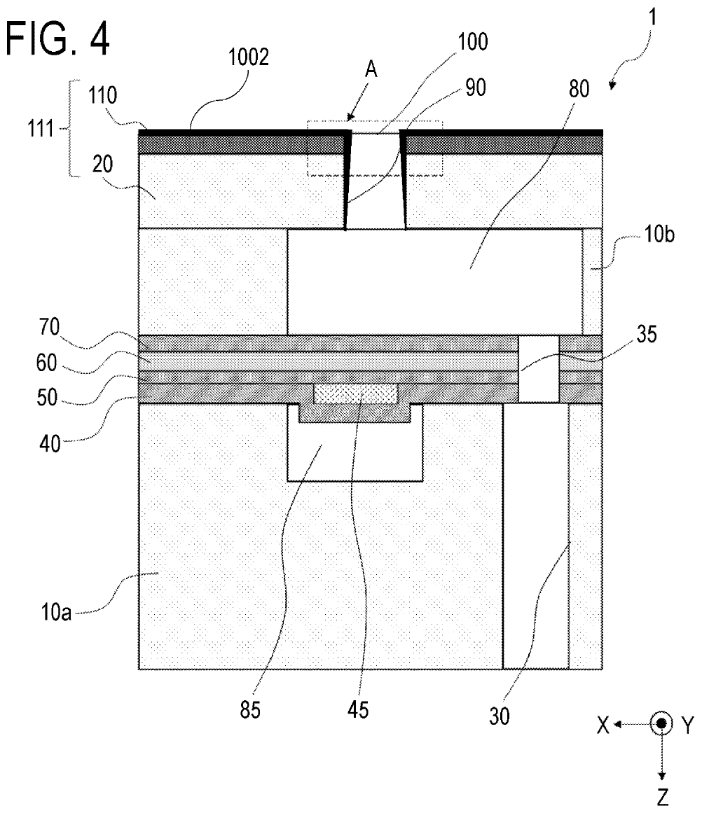

A liquid discharge substrate 1 according to an embodiment of the present disclosure will be described with reference to FIGS. 1 and 4. The embodiment is an example of the present disclosure, and is not intended to limit the scope of the present disclosure to this embodiment. Although the liquid discharge substrate of the embodiment shown below is applied to a liquid discharge head using a piezoelectric element, it can also be applied to a liquid discharge head using a heat generating resistor element or an electrothermal conversion element. The discharged liquid is not limited to ink, as long as it can be discharged from the liquid discharge head.

In the following description and drawings, a Z direction indicates a direction in which a silicon substrate and a silicon compound film (silicon oxide film) are laminated. In the present embodiment, a case in which a direction in which a through hole communicating with a nozzle (opening) penetrates a nozzle substrate (a depth direction of the through hole) is parallel to the Z direction will be illustrated. Any direction orthogonal to the Z direction is defined as an X direction. A direction orthogonal to both the Z direction and the X direction is defined as a Y direction. A diameter of the nozzle or through hole indicates a dimension in an XY plane, a radial direction indicates a direction from a center axis of the hole to an outer circumference of the hole in the XY plane, and the diameter is equal to a diameter in the XY plane in the case of the hole or through hole having a circular cross-section.

### Configuration of Liquid Discharge Head

FIG. 1 is a cross-sectional view showing a main portion (part) of a liquid discharge substrate 1 included in an ink discharge head of an inkjet recording apparatus of a first embodiment. Also, the inkjet recording apparatus including the liquid discharge substrate 1 is provided with the ink discharge head provided with the liquid discharge substrate 1, a liquid storage portion that stores liquid supplied to the ink discharge head, a conveying mechanism for a recording medium on which recording is performed, and the like.

An actuator substrate 10b is made of silicon and is disposed below a nozzle substrate 111. The actuator substrate 10b supports a vibration film 60 via a protective film 40 and an insulating film 50. The vibration film 60 is bonded to an insulating film 70. The insulating film 70 forms one surface of a cavity 80 and defines the cavity 80 together with the actuator substrate 10b and a silicon substrate 20. A flow passage substrate 10a is disposed below the actuator substrate 10b. Ink is supplied to the cavity 80 through a through hole 30 penetrating the flow passage substrate 10a in the Z direction (laminating direction) and a liquid flow passage 35 penetrating the protective film 40, the insulating film 50, the vibration film 60, and the insulating film 70 in the Z direction. The cavity 80 communicates with a nozzle 90.

A piezoelectric element 45 is disposed between the protective film 40 and the insulating film 50. The piezoelectric element 45 is an example of an actuator element that generates energy for discharging the ink in the cavity (in the cavity 80) from a discharge port 100. A cavity 85 is formed on a side of the protective film 40 opposite to a side on which the piezoelectric element 45 is provided. The silicon substrate 20 and a silicon oxide film 110 (silicon compound film) form the nozzle substrate 111. The silicon substrate 20 has the nozzle 90 communicating with the cavity 80. The discharge port 100 from which the ink is discharged is formed on the furthest downstream side in a discharging direction of the nozzle 90. A diameter of the discharge port 100 is determined from an amount of ink discharged, and is, for example, about 5 μm to 50 μm.

By applying a drive voltage to the piezoelectric element 45 from a power source (not shown), the vibration film 60 vibrates, and the cavity 80 repeats expansion and contraction. By pressurizing the ink in the cavity 80, the ink passes through the nozzle 90 and is discharged from the discharge port 100.

The nozzle substrate 111 to which the actuator substrate 10b is bonded will be described in detail. The nozzle substrate 111 is made of an SOI substrate in which the silicon oxide film 110 is bonded to the silicon substrate 20. The SOI substrate is bonded to the actuator substrate 10b, and then the silicon part is ground, polished, and thinned until the silicon oxide film 110 is exposed, and thus the nozzle substrate 111 can be produced. Then, the discharge port 100 is formed by etching, and thus the liquid discharge substrate 1 shown in FIG. 1 can be produced.

In the liquid discharge substrate 1 of the first embodiment, as shown in FIG. 1, a protective film 1001 with a high refractive index is used to cover a surface of the nozzle substrate 111, an inner wall surface of the nozzle 90, the cavity 80 which is a flow passage communicating with the nozzle 90, the liquid flow passage 35, and an inner wall surface of the through hole 30, thereby providing ink resistance. The protective film 1001 is formed by ALD film formation (atomic layer deposition).

In a liquid discharge substrate 1 of a second embodiment, as shown in FIG. 4, only the surface of the nozzle substrate 111 and the inner wall surface of the nozzle 90 are partially covered with a protective film 1002. In this case, the protective film 1002 is formed by plasma-excited chemical vapor deposition (PECVD). In any of configurations of the embodiments, the ink resistance can be improved by covering the nozzle 90 part with a protective film having high ink resistance.

In order to ensure the recording quality of the inkjet recording apparatus, it is desirable that an opening dimension of the nozzle 90 of the liquid discharge substrate 1 (a diameter of the discharge port 100) be constant. This is because, if the opening dimension of the nozzle 90 is not constant, the accuracy of an amount of ink droplets discharged will decrease, resulting in a decrease in recording quality. In order to maintain the opening dimension of the nozzle 90 constant, it is required to measure a minute opening of the nozzle 90 with high accuracy. As a method for measuring the opening dimension of the nozzle 90, there is a method for measuring a step at an opening end portion of the nozzle 90 in a non-contact manner by white light interferometry using white light.

As in the first and second embodiments, if the discharge port 100 of the nozzle 90 is covered with the protective film 1001 or the protective film 1002, there are cases in which the opening dimension of the nozzle 90 cannot be measured properly using the white light interferometry. In detail, an intensity of light reflected from the nozzle substrate 111 out of light with approximately 530 nm, which is a central wavelength of white light (light with continuous wavelengths of approximately 380 to 780 nm) used for measurements by white light interferometry may be lower than an intensity required to perform measurements properly.

Thus, the first and second embodiments show configurations in which measurements can be performed properly by white light interferometry.

### First Embodiment

In the first embodiment, as shown in FIG. 1, the entire liquid discharge substrate 1 is coated with a TaO film serving as the protective film 1001 using the ALD method.

Table 1 shows film thicknesses of the silicon oxide film 110 (SiO film) and the protective film 1001 (TaO film), a reflectance of the nozzle substrate 111 to white light, whether or not the opening dimension of the nozzle 90 can be measured by white light interferometry, and the presence or absence of ink resistance.

TABLE 1

| SiO Film | TaO Film | | | |
|---|---|---|---|---|
| thickness | thickness | | Nozzle | Ink |
| [nm] | [nm] | Reflectance | measurement | resistance |
| 270 | 0 | 0.14 | No | No |
| 360 | 0 | 0.28 | Yes | No |
| 270 | 60 | 0.57 | Yes | Yes |
| 360 | 60 | 0.07 | No | Yes |
| 270 | 120 | 0.14 | No | Yes |
| 310 | 120 | 0.22 | Yes | Yes |
| 270 | 180 | 0.07 | No | Yes |
| 360 | 180 | 0.57 | Yes | Yes |

The film thickness of the silicon oxide film 110 can be adjusted in accordance with an etching time. The film thickness of the protective film 1001 can be adjusted in accordance with a film formation time.

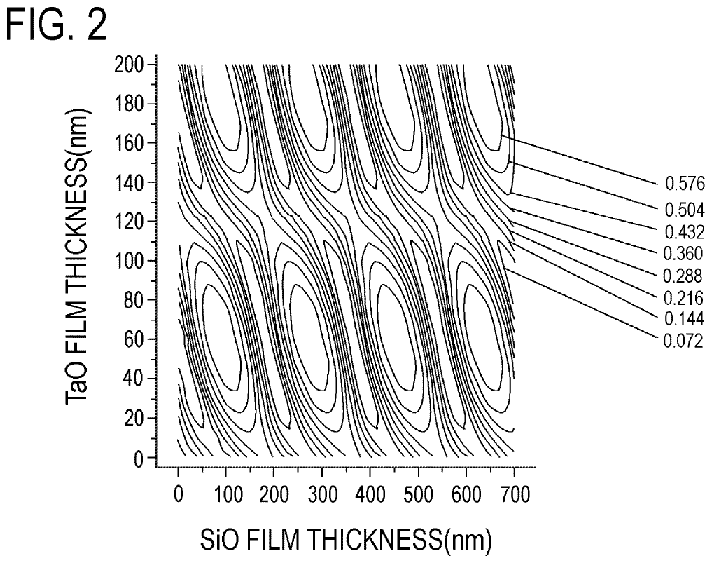

FIG. 2 is a diagram showing a relationship between the silicon oxide film 110 (SiO film), the protective film 1001 (TaO film), and the reflectance. FIG. 2 shows the results obtained by simulating a reflectance of a substrate obtained by simply laminating a SiO film and a TaO film on a silicon substrate when the substrate is irradiated with light having a wavelength of 530 nm. FIG. 2 shows the reflectance in a contour diagram in which the horizontal axis is the film thickness of the SiO film and the vertical axis is the film thickness of the TaO film. In the simulation, analysis was performed with the refractive index of the SiO film set to 1.46 and the refractive index of the TaO film set to 2.18.

From the simulation analysis results shown in Table 1 and FIG. 2, it has been found that the reflectance of the nozzle substrate 111 is required to be 0.2 or more in order to properly measure the opening dimension of the nozzle 90 by the white light interferometry for the liquid discharge substrate 1 entirely covered with the TaO film serving as the protective film.

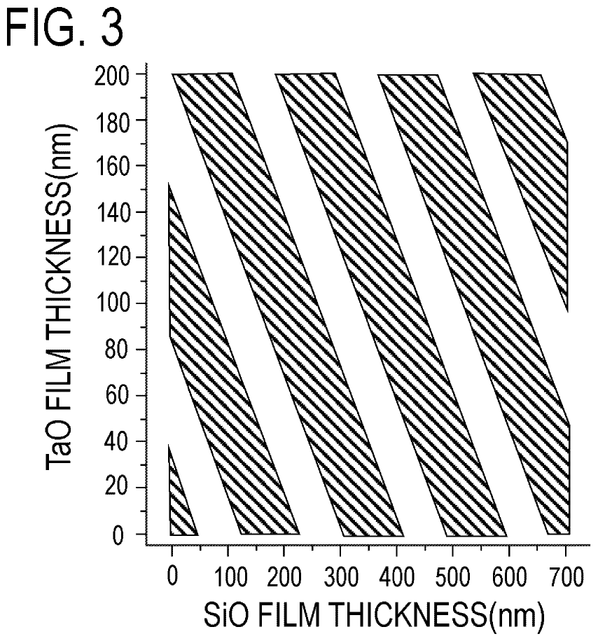

FIG. 3 is a diagram showing appropriate film thicknesses of the SiO film and the TaO film. FIG. 3 is a graph obtained on the basis of the simulation analysis diagram of FIG. 2, where the horizontal axis (X axis) represents the SiO film thickness and the vertical axis (Y axis) represents the TaO film thickness.

In FIG. 3, the shaded areas indicate ranges of values that are to be satisfied by the SiO film thickness and the TaO film thickness in order to obtain the reflectance that can be properly measured by white light interferometry.

In FIG. 3, the part of the nozzle substrate 111 in which the reflectance is 0.2 or more was obtained using a linear function on the basis of the simulation analysis diagram of FIG. 2. Specifically, when points of high reflectance in the simulation analysis diagram of FIG. 2 are connected to each other with a linear function, a straight line with a slope of −1.5 is obtained (Y=−1.5X). Due to the periodic characteristics, +180n (n: 0, 1, 2, 3, 4, and 5) is added to intercept term. In addition, the tolerance b=−40 to 40.

In summary, the ranges of values that are to be satisfied by the SiO film thickness and the TaO film thickness in order to obtain the reflectance that can be properly measured by white light interferometry can be expressed as follows. That is, when the film thickness of the silicon oxide film is defined as X [nm], the film thickness of the TaO film is defined as Y [nm], and the tolerance is defined as b [nm],

$$Y = - 1.5 X + 180 n + b$$

$$n = 0 , 1 , 2 , 3 , 4 , and 5$$

$$\vert b \vert \leq 40$$

$$Y > 0$$

When the entire surface and inner wall surface of the nozzle substrate 111 are covered with the protective film 1001 (TaO film) using the ALD method, the film thickness X of the silicon oxide film 110 (SiO film) forming the nozzle substrate 111 and the film thickness Y of the protective film 1001 (TaO film) are set to satisfy the above expressions. Thus, since the reflectance of the white light used in the white light interferometry on the nozzle substrate 111 is 0.2 or more, the opening dimension of the nozzle 90 can be properly measured by the white light interferometry. Accordingly, the opening dimension of the nozzle 90 can be properly managed on the basis of the measurement results, and it becomes possible to maintain a constant recording quality of the inkjet recording apparatus provided with the liquid discharge substrate 1 having the nozzle substrate 111. In the liquid discharge substrate 1, it is possible to impart resistance to the ink not only to the vicinity of the discharge port 100 of the nozzle 90 and the surface of the nozzle substrate 111, but also to the entire flow passage of the liquid discharge substrate 1.

### Second Embodiment

In the second embodiment, as shown in FIG. 4, a SiC film is applied as the protective film 1002 to the surface of the liquid discharge substrate 1 and the inner wall surface of the nozzle 90 using the PECVD method.

Table 2 shows the film thicknesses of the silicon oxide film 110 (SiO film) and the protective film 1002 (SiC film), the reflectance of the nozzle substrate 111 to white light, whether or not the opening dimension of the nozzle 90 can be measured by the white light interferometry, and the presence or absence of ink resistance.

TABLE 2

| SiO Film | SiC Film | | | |
|---|---|---|---|---|
| thickness | thickness | | Nozzle | Ink |
| [nm] | [nm] | Reflectance | measurement | resistance |
| 270 | 0 | 0.16 | No | No |
| 360 | 0 | 0.32 | Yes | No |
| 180 | 55 | 0.07 | No | Yes |
| 270 | 55 | 0.63 | Yes | Yes |
| 270 | 110 | 0.16 | No | Yes |
| 310 | 110 | 0.24 | Yes | Yes |
| 180 | 165 | 0.07 | No | Yes |
| 270 | 165 | 0.63 | Yes | Yes |

The film thickness of the silicon oxide film 110 can be adjusted in accordance with an etching time. The film thickness of the protective film 1002 can be adjusted in accordance with a film formation time.

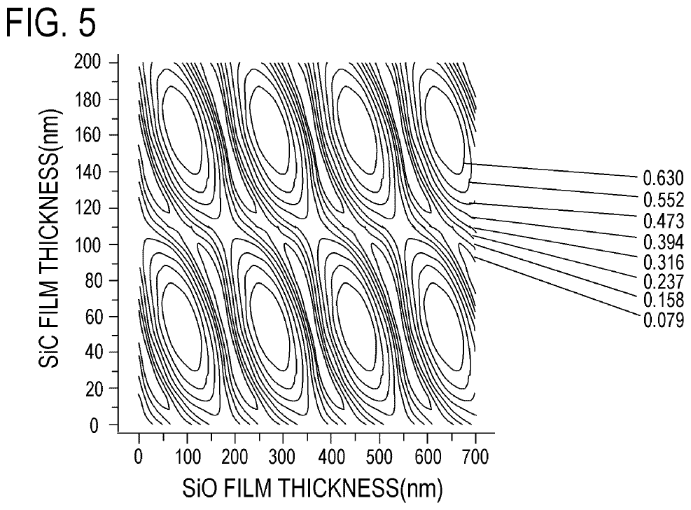

FIG. 5 is a diagram showing a relationship between the silicon oxide film 110 (SiO film), the protective film 1002 (SiC film), and the reflectance. FIG. 5 shows the results obtained by simulating a reflectance of a substrate obtained by simply laminating a SiO film and a SiC film on a silicon substrate when the substrate is irradiated with light having a wavelength of 530 nm. FIG. 5 shows the reflectance in a contour diagram in which the horizontal axis is the film thickness of the SiO film and the vertical axis is the film thickness of the SiC film. In the simulation, analysis was performed with the refractive index of the SiO film set to 1.46 and the refractive index of the SiC film set to 2.45.

From the simulation analysis results shown in Table 2 and FIG. 5, it has been found that the reflectance of the nozzle substrate 111 is required to be 0.2 or more in order to properly measure the opening dimension of the nozzle 90 by the white light interferometry for the liquid discharge substrate 1 in which the nozzle 90 part is covered with the SiC film as the protective film.

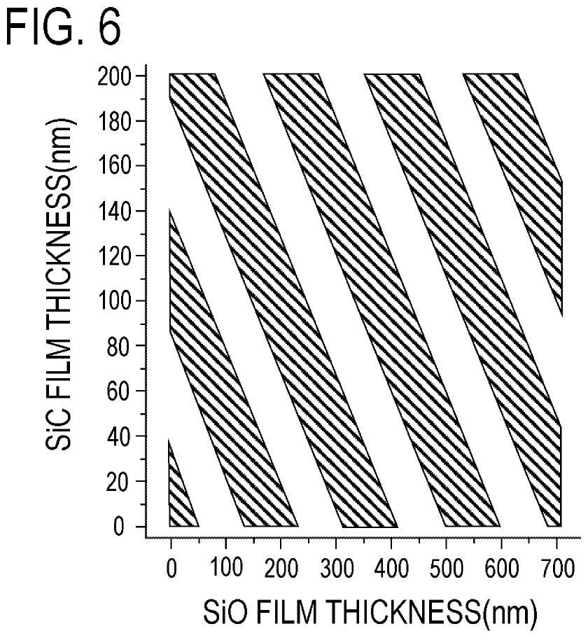

FIG. 6 is a diagram showing appropriate film thicknesses of the SiO film and the SiC film. FIG. 6 is a graph obtained on the basis of the simulation analysis diagram of FIG. 5, where the horizontal axis (X axis) represents the SiO film thickness and the vertical axis (Y axis) represents the SiC film thickness.

In FIG. 6, the shaded areas indicate ranges of values that are to be satisfied by the SiO film thickness and the SiC film thickness in order to obtain the reflectance that can be properly measured by the white light interferometry.

In FIG. 6, the part of the nozzle substrate 111 in which the reflectance is 0.2 or more was obtained using a linear function on the basis of the simulation analysis diagram of FIG. 5. Specifically, when points of high reflectance in the simulation analysis diagram of FIG. 5 are connected to each other with a linear function, a straight line with a slope of −1.636 is obtained (Y=−1.636X). Due to the periodic characteristics, +180n (n: 0, 1, 2, 3, 4, and 5) is added to the intercept term. In addition, the tolerance b=−40 to 40.

In summary, the ranges of values that are to be satisfied by the SiO film thickness and the SiC film thickness in order to obtain the reflectance that can be properly measured by the white light interferometry can be expressed as follows. That is, when the film thickness of the silicon oxide film is defined as X [nm], the film thickness of the SiC film is defined as Y [nm], and the tolerance is defined as b [nm],

$$Y = - 1.636 X + 180 n + b$$

$$n = 0 , 1 , 2 , 3 , 4 , and 5$$

$$\vert b \vert \leq 40$$

$$Y > 0$$

When the surface of the nozzle substrate 111 and the nozzle 90 part are covered with the protective film 1002 (SiC film) using the PECVD method, the film thickness X of the silicon oxide film 110 (SiO film) forming the nozzle substrate 111 and the film thickness Y of the protective film 1002 (SiC film) are set as above. Thus, the reflectance of the white light used in the white light interferometry on the nozzle substrate 111 is 0.2 or more, and thus the opening dimension of the nozzle 90 can be properly measured by the white light interferometry. Accordingly, the opening dimension of the nozzle 90 can be properly managed on the basis of the measurement results, and the recording quality of the inkjet recording apparatus provided with the liquid discharge substrate 1 having the nozzle substrate 111 can be maintained constant. In the liquid discharge substrate 1, it is possible to impart resistance to the ink to the vicinity of the discharge port 100 of the nozzle 90 and the surface of the nozzle substrate 111.

According to the present disclosure, it is possible to accurately measure the dimensions of the nozzle using the white light interferometry in the nozzle substrate that is coated with the protective film to enhance resistance to the liquid.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-140788, filed on Aug. 22, 2024, which is hereby incorporated by reference herein in its entirety.

What is claimed is:

1. A nozzle substrate configured by laminating a silicon substrate and a silicon oxide film covering a surface of the silicon substrate and provided with a discharge port that discharges liquid, comprising:
a nozzle configured to penetrate the nozzle substrate and communicate with the discharge port; and
a protective film configured to cover at least a surface of the silicon oxide film and an inner wall surface of the nozzle and have resistance to the liquid,
wherein a reflectance of white light on a surface of the nozzle substrate used in measuring the nozzle as a step by white light interferometry is 0.2 or more.

2. The nozzle substrate according to claim 1,
wherein a reflectance of light having a wavelength of 530 nm on a surface of the nozzle substrate of light used in white light interferometry is 0.2 or more.

3. The nozzle substrate according to claim 1,
wherein the protective film is a TaO film.

4. The nozzle substrate according to claim 3,
wherein in a case where a film thickness of the silicon oxide film is defined as X [nm], a film thickness of the TaO film is defined as Y [nm], and a tolerance is defined as b [nm],
$$Y = - 1.5 X + 180 n + b$$
$$where n = 0 , 1 , 2 , 3 , 4 , and 5 ,$$
$$\vert b \vert \leq 40 , and$$
$$Y > 0$$
is satisfied.

5. The nozzle substrate according to claim 1,
wherein the protective film is a SiC film.

6. The nozzle substrate according to claim 5,
wherein in a case where a film thickness of the silicon oxide film is defined as X [nm], a film thickness of the SiC film is defined as Y [nm], and a tolerance is defined as b [nm],
$$Y = - 1.636 X + 180 n + b$$
$$where n = 0 , 1 , 2 , 3 , 4 , and 5 ,$$
$$\vert b \vert \leq 40 , and$$
$$Y > 0$$
is satisfied.

7. The nozzle substrate according to claim 1,
further comprising:
an actuator substrate disposed below the silicon substrate, the actuator substrate having a cavity communicating with the nozzle and an actuator element generating energy to cause the liquid in the cavity to be discharged from the discharge port; and
a flow passage substrate disposed below the actuator substrate and provided with a flow passage communicating with the cavity,
wherein the protective film covers the cavity and an inner wall surface of the flow passage.
